(19) United States
(12) Patent Application Publication
(10) Pub. No.: US 2012/0307916 A1
(43) Pub. Date: Dec. 6, 2012

(54) TRANSMITTING APPARATUS USING DC CARRIER AND RECEIVING APPARATUS USING DC CARRIER

(76) Inventors: Tsang-Yi CHENG, Taoyuan County (TW); Chia-Hsiang LI, Taoyuan County (TW)

(21) Appl. No.: 13/185,711

(22) Filed: Jul. 19, 2011

(30) Foreign Application Priority Data
May 31, 2011 (TW) 100118948

(51) Int. Cl. H04L 25/00

(52) U.S. Cl. 375/257

(57) ABSTRACT

A transmitting apparatus using DC carrier includes a microcontroller, a transmitting-side communication circuit, an induction reactance unit, a DC isolation unit, and a DC power and signal output terminal. An information signal is received by the microcontroller. The information signal is transferred to a communication signal by the transmitting-side communication circuit. A DC power is received by the induction reactance unit. The DC isolation unit avoids the transmitting-side communication circuit to be impacted by the DC power. The communication signal and the DC power are transmitted from the DC power and signal output terminal to an electric wire. The transmitting apparatus using DC carrier of the present invention can transmit the DC power and the communication signal at the same time with an electric wire to save labor cost and electric wire cost.

### BACKGROUND OF THE INVENTION

1. Field of the Invention

The present invention relates to a transmitting apparatus and a receiving apparatus, and especially relates to a transmitting apparatus using DC carrier and a receiving apparatus using DC carrier.

2. Description of Prior Art

An uninterruptible power supply (UPS) is an electrical apparatus that provides emergency power to electronic devices when the input power source fails. Moreover, a DC uninterruptible power supply can supply DC power.

FIG. 1 shows a block diagram of the application of DC uninterruptible power supply of prior art. A DC uninterruptible power supply 10 is electrically connected to an optical network terminal device 20 with a plurality of electric wires 30. The DC uninterruptible power supply 10 hereby provides emergency power to the optical network terminal device 20 when the input power source fails.

Viewed from top to bottom direction, the first and the second of the electric wires 30 (at least 18 AWG) are used to transmit power, while, the other five electric wires (24 AWG) are used for communication. Besides, each of the DC uninterruptible power supply 10 and the optical network terminal device 20 has a phoenix connector (not shown in the FIG. 1) with seven legs to connect to the electric wires 30.

The disadvantage of the DC uninterruptible power supply of prior art mentioned above is using too many electric wires so that labor cost (installing electric wires) and electric wire cost are higher.

### SUMMARY OF THE INVENTION

In order to solve the above-mentioned problems, an object of the present invention is to provide a transmitting apparatus using DC carrier. The transmitting apparatus using DC carrier can transmit DC power and communication signals at the same time with an electric wire to save labor cost and electric wire cost.

In order to solve the above-mentioned problems, another object of the present invention is to provide a receiving apparatus using DC carrier. The receiving apparatus using DC carrier can receive DC power and communication signals at the same time with an electric wire to save labor cost and electric wire cost.

In order to achieve the object of the present invention mentioned above, the transmitting apparatus using DC carrier of the present invention is applied to a DC output unit and an information signal output unit. The transmitting apparatus using DC carrier includes a microcontroller electrically connected to the information signal output unit, a transmitting-side communication circuit electrically connected to the microcontroller, an induction reactance unit electrically connected to the DC output unit, a DC isolation unit electrically connected to the transmitting-side communication circuit and the induction reactance unit, and a DC power and signal output terminal electrically connected to the induction reactance unit and the DC isolation unit.

An information signal is sent from the microcontroller to the transmitting-side communication circuit after the information signal sent from the information signal output unit is received by the microcontroller. A communication signal is sent from the transmitting-side communication circuit to the DC power and signal output terminal through the DC isolation unit after the information signal is received by the transmitting-side communication circuit. A DC power is sent from the DC output unit to the DC power and signal output terminal through the induction reactance unit. The DC power and the communication signal are sent from the DC power and signal output terminal to an electric wire.

In order to achieve another object of the present invention mentioned above, the receiving apparatus using DC carrier of the present invention is applied to a DC power receiving unit and an information signal receiving unit. The receiving apparatus using DC carrier includes a microcontroller electrically connected to the information signal receiving unit, a receiving-side communication circuit electrically connected to the microcontroller, an induction reactance unit electrically connected to the DC power receiving unit, a DC isolation unit electrically connected to the receiving-side communication circuit and the induction reactance unit, and a DC power and signal input terminal electrically connected to the induction reactance unit and the DC isolation unit.

An information signal is sent from the receiving-side communication circuit to the microcontroller after a communication signal sent from the DC power and signal input terminal and through the DC isolation unit is received by the receiving-side communication circuit. The information signal is sent from the microcontroller to the information signal receiving unit after the information signal is received by the microcontroller. A DC power is sent from the DC power and signal input terminal to the DC power receiving unit through the induction reactance unit. The DC power and the communication signal are hereby sent from an electric wire to the DC power and signal input terminal.

The efficiency of the present invention is to transmit (receive) DC power and communication signals at the same time with an electric wire to save labor cost and electric wire cost.

### BRIEF DESCRIPTION OF DRAWING

FIG. 1 shows a block diagram of the application of DC uninterruptible power supply of prior art.

FIG. 2 shows a block diagram of transmitting apparatus using DC carrier of the present invention.

FIG. 3 shows a block diagram of receiving apparatus using DC carrier of the present invention.

FIG. 4 shows a block diagram of the application of the present invention.

FIG. 5 shows a schematic view of an embodiment of transmitting apparatus using DC carrier of the present invention.

FIG. 6 shows a schematic view of an embodiment of receiving apparatus using DC carrier of the present invention.

FIG. 7 shows a schematic view of an embodiment of transmitting side only transmitting DC power.

FIG. 8 shows a schematic view of an embodiment of receiving side only receiving DC power.

### DETAILED DESCRIPTION OF THE INVENTION

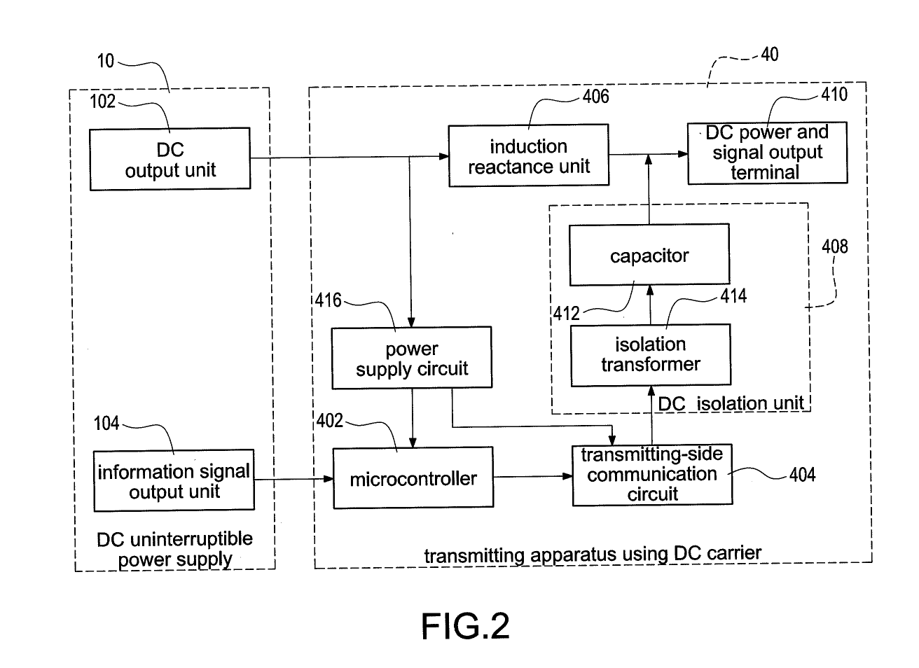

FIG. 2 shows a block diagram of transmitting apparatus using DC carrier of the present invention. The transmitting apparatus using DC carrier 40 of the present invention is applied to a DC uninterruptible power supply 10. The DC uninterruptible power supply 10 includes a DC output unit 102, and an information signal output unit 104. The transmitting apparatus using DC carrier 40 includes a microcontroller 402, a transmitting-side communication circuit 404, an induction reactance unit 406, a DC isolation unit 408, a DC power and signal output terminal 410, and a power supply circuit 416. The DC isolation unit 408 includes a capacitor 412 and an isolation transformer 414.

The microcontroller 402 is electrically connected to the information signal output unit 104. The transmitting-side communication circuit 404 is electrically connected to the microcontroller 402. The induction reactance unit 406 is electrically connected to the DC output unit 102. The DC isolation unit 408 is electrically connected to the transmitting-side communication circuit 404 and the induction reactance unit 406. The DC power and signal output terminal 410 is electrically connected to the induction reactance unit 406 and the DC isolation unit 408.

The capacitor 412 is electrically connected to the induction reactance unit 406 and the DC power and signal output terminal 410. The isolation transformer 414 is electrically connected to the transmitting-side communication circuit 404 and the capacitor 412. The power supply circuit 416 is electrically connected to the DC output unit 102, the induction reactance unit 406, the microcontroller 402, and the transmitting-side communication circuit 404.

An information signal is sent from the microcontroller 402 to the transmitting-side communication circuit 404 after the information signal sent from the information signal output unit 104 is received by the microcontroller 402. A communication signal is sent from the transmitting-side communication circuit 404 to the DC power and signal output terminal 410 through the DC isolation unit 408 after the information signal is received by the transmitting-side communication circuit 404. A DC power is sent from the DC output unit 102 to the DC power and signal output terminal 410 through the induction reactance unit 406. The DC power and the communication signal are hereby sent from the DC power and signal output terminal 410 to an electric wire (not shown in the FIG. 2, for example, a coaxial cable).

The DC power (for example, 12 voltages) is sent from the DC output unit 102 of the DC uninterruptible power supply 10 to the transmitting apparatus using DC carrier 40. The information signal (for example, the parameters of the DC power) is sent from the information signal output unit 104 of the DC uninterruptible power supply 10 to the transmitting apparatus using DC carrier 40.

The transmitting-side communication circuit 404 can be an encoding circuit to encode the information signal into the communication signal. The transmitting-side communication circuit 404 can be a modulation circuit as well to modulate the information signal into the communication signal. The communication signals can be pulse signals or modulated signals or any other high frequency signals that can pass, through the DC isolation unit 408, to the DC power and signal output terminal 410.

The induction reactance unit 406 can be a high impedance choke or an inductor to avoid the communication signal to fade in DC carriers. The DC isolation unit 408 is used to avoid the DC power to transmit to the transmitting-side communication circuit 404. The capacitor 412 can be a capacitor. The isolation transformer 414 can be an isolation transformer. The power supply circuit 416 can be a voltage regulator or a negative booster to supply driving power to the microcontroller 402 and the transmitting-side communication circuit 404.

The transmitting apparatus using DC carrier 40 of the present invention can transmit the DC power and the communication signal through the DC power and signal output terminal 410 at the same time.

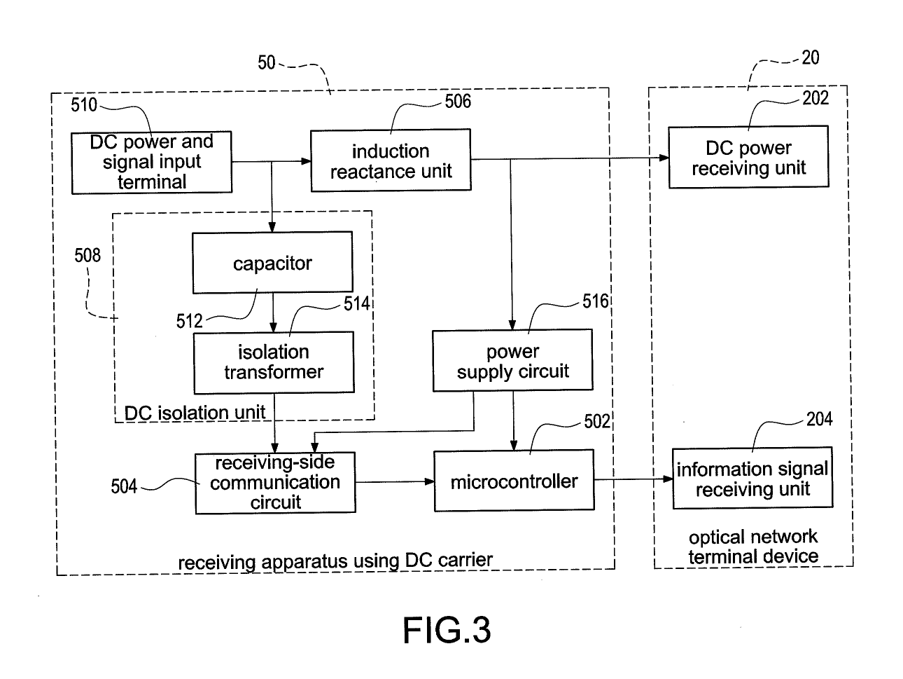

FIG. 3 shows a block diagram of receiving apparatus using DC carrier of the present invention. The receiving apparatus using DC carrier 50 of the present invention is applied to an optical network terminal device 20 (or any other electronic devices). The optical network terminal device 20 includes a DC power receiving unit 202 and an information signal receiving unit 204.

The receiving apparatus using DC carrier 50 includes a microcontroller 502, a receiving-side communication circuit 504, an induction reactance unit 506, a DC isolation unit 508, a DC power and signal input terminal 510, and a power supply circuit 516. The DC isolation unit 508 includes a capacitor 512 and an isolation transformer 514.

The microcontroller 502 is electrically connected to the information signal receiving unit 204. The receiving-side communication circuit 504 is electrically connected to the microcontroller 502. The induction reactance unit 506 is electrically connected to the DC power receiving unit 202.

The DC isolation unit 508 is electrically connected to the receiving-side communication circuit 504 and the induction reactance unit 506. The DC power and signal input terminal 510 is electrically connected to the induction reactance unit 506 and the DC isolation unit 508.

The capacitor 512 is electrically connected to the induction reactance unit 506 and the DC power and signal input terminal 510. The isolation transformer 514 is electrically connected to the receiving-side communication circuit 504 and the capacitor 512. The power supply circuit 516 is electrically connected to the DC power receiving unit 202, the induction reactance unit 506, the microcontroller 502, and the receiving-side communication circuit 504.

An information signal is sent from the receiving-side communication circuit 504 to the microcontroller 502 after a communication signal sent from the DC power and signal input terminal 510 and through the DC isolation unit 508 is received by the receiving-side communication circuit 504. The information signal is sent from the microcontroller 502 to the information signal receiving unit 204 after the information signal is received by the microcontroller 502. A DC power is sent from the DC power and signal input terminal 510 to the DC power receiving unit 202 through the induction reactance unit 506. The DC power and the communication signal are hereby sent from an electric wire (not shown in the FIG. 3, for example, a coaxial cable) to the DC power and signal input terminal 510.

The DC power can be for example 12 voltages. The information signal can be for example the parameters of the DC power.

The receiving-side communication circuit 504 can be a decoding circuit to decode the communication signal into the information signal. The receiving-side communication circuit 504 can be a demodulation circuit as well to demodulate the communication signal into the information signal. The communication signals can be pulse signals or modulated signals or any other high frequency signals that can pass through the DC isolation unit 508 to the receiving-side communication circuit 504.

The induction reactance unit 506 can be a high impedance choke or an inductor to avoid the communication signal to fade in DC carriers. The DC isolation unit 508 is used to avoid the DC power to transmit to the receiving-side communication circuit 504. The capacitor 512 can be a capacitor. The isolation transformer 514 can be an isolation transformer. The power supply circuit 516 can be a voltage regulator or a negative booster to supply driving power to the microcontroller 502 and the receiving-side communication circuit 504.

The receiving apparatus using DC carrier 50 of the present invention can receive the DC power and the communication signal through the DC power and signal input terminal 510 at the same time.

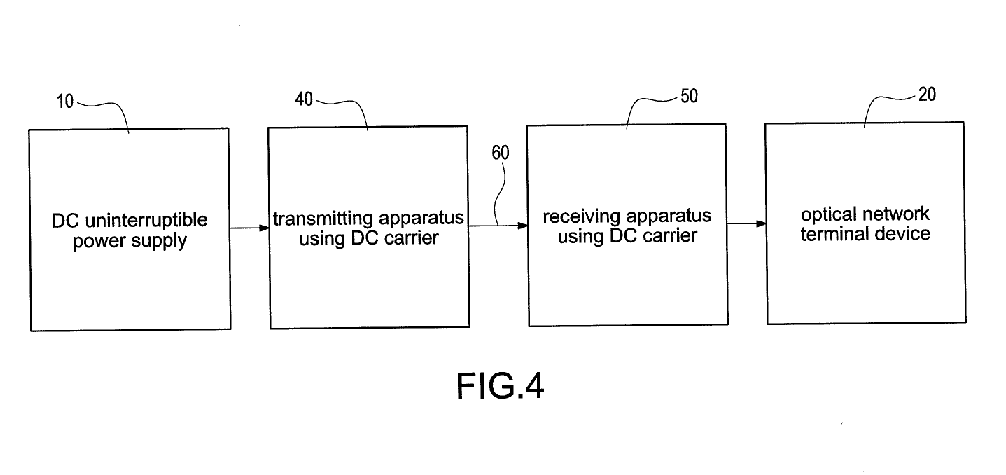

FIG. 4 shows a block diagram of the application of the present invention. An electric wire 60 is connected between the DC power and signal output terminal 410 of the transmitting apparatus using DC carrier 40 and the DC power and signal input terminal 510 of the receiving apparatus using DC carrier 50.

The DC power and the communication signal are sent from the transmitting apparatus using DC carrier 40 to the receiving apparatus using DC carrier 50 through the electric wire 60 after the DC power, and the information signal are sent from the DC uninterruptible power supply 10 to the transmitting apparatus using DC carrier 40. The DC power and the information signal are sent from the receiving apparatus using DC carrier 50 to the optical network terminal device 20 after the DC power and the communication signal are received by the receiving apparatus using DC carrier 50.

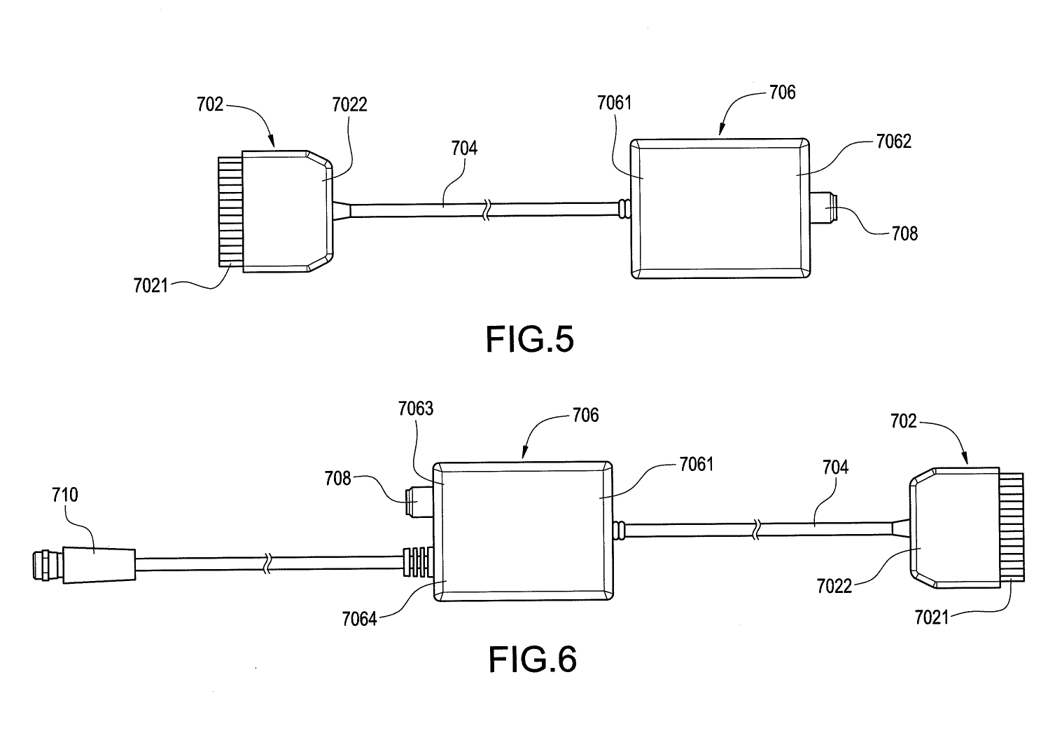

FIG. 5 shows a schematic view of an embodiment of transmitting apparatus using DC carrier of the present invention. A first-side 7021 of a phoenix connector 702 with seven legs (or any other connectors) is connected to the DC uninterruptible power supply 10 (the DC output unit 102 and the information signal output unit 104). A second-side 7022 of the phoenix connector 702 is connected to a pipe 704. The pipe 704 is connected to a first-side 7061 of a housing 706. A second-side 7062 of the housing 706 is connected to a wire connector 708 (i.e. the wire connector 708 is arranged corresponding to the pipe 704) to connect to the electric wire 60.

FIG. 6 shows a schematic view of an embodiment of receiving apparatus using DC carrier of the present invention. A first-side 7021 of a phoenix connector 702 with seven legs (or any other connectors) is connected to the optical network terminal device 20 (the DC power receiving unit 202 and the information signal receiving unit 204). A second-side 7022 of the phoenix connector 702 is connected to a pipe 704. The pipe 704 is connected to a first-side 7061 of a housing 706. A first-part 7063 of the housing 706 is connected to a wire connector 708 (i.e. the wire connector 708 is arranged corresponding to the pipe 704) to connect to the electric wire 60. A second-part 7064 of the housing 706 is connected to a connection wire 710 to connect to other electronic devices for expansion.

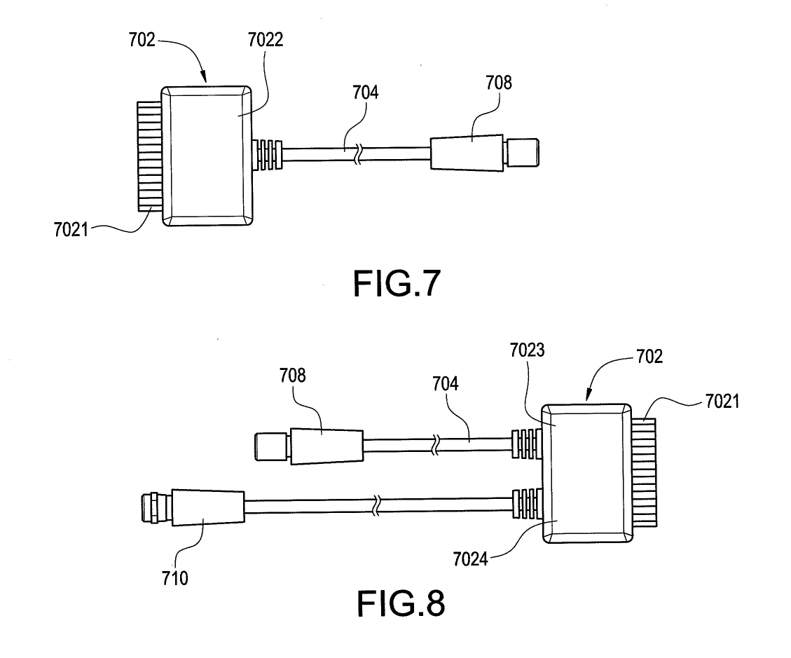

The present invention can transmit only the DC power but not the information signal. FIG. 7 shows a schematic view of an embodiment of transmitting side only transmitting DC power. A first-side 7021 of a phoenix connector 702 with seven legs (or any other connectors) is connected to the DC uninterruptible power supply 10 (the DC output unit 102). A second-side 7022 of the phoenix connector 702 is connected to a pipe 704. The pipe 704 is connected to a wire connector 708 (i.e. the wire connector 708 is arranged corresponding to the pipe 704) to connect to the electric wire 60.

FIG. 8 shows a schematic view of an embodiment of receiving side only receiving DC power. A first-side 7021 of a phoenix connector 702 with seven legs (or any other connectors) is connected to the optical network terminal device 20 (the DC power receiving unit 202). A first-part 7023 of the phoenix connector 702 is connected to a pipe 704. The pipe 704 is connected to a wire connector 708 (i.e. the wire connector 708 is arranged corresponding to the pipe 704) to connect to the electric wire 60. A second-part 7024 of the phoenix connector 702 is connected to a connection wire 710 to connect to other electronic devices for expansion.

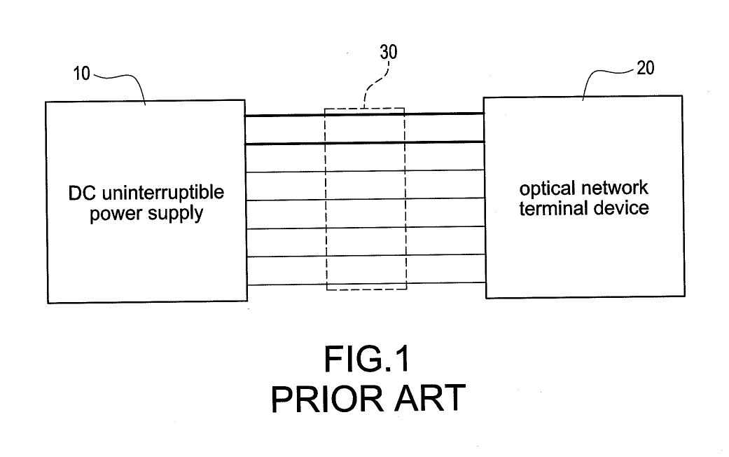

Please refer to FIG. 1 again. The prior art uses seven electric wires to transmit DC power and information signals. The present invention uses only a pair of electric wires (i.e. two electric wires, one for positive and the other for negative) to transmit DC power and communication signals at the same time to save labor cost (installing electric wires) and electric wire cost.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A transmitting apparatus using DC carrier applied to a DC output unit and an information signal output unit, the transmitting apparatus using DC carrier including:
a microcontroller electrically connected to the information signal output unit;
a transmitting-side communication circuit electrically connected to the microcontroller;
an induction reactance unit electrically connected to the DC output unit;
a DC isolation unit electrically connected to the transmitting-side communication circuit and the induction reactance unit; and
a DC power and signal output terminal electrically connected to the induction reactance unit and the DC isolation unit,
wherein an information signal is sent from the microcontroller to the transmitting-side communication circuit after the information signal sent from the information signal output unit is received by the microcontroller; a communication signal is sent from the transmitting-side communication circuit to the DC power and signal output terminal through the DC isolation unit after the information signal is received by the transmitting-side communication circuit; a DC power is sent from the DC output unit to the DC power and signal output terminal through the induction reactance unit; the DC power and the communication signal are sent from the DC power and signal output terminal to an electric wire.

2. The transmitting apparatus using DC carrier in claim 1, wherein the DC isolation unit includes:
a capacitor electrically connected to the induction reactance unit and the DC power and signal output terminal; and
an isolation transformer electrically connected to the transmitting-side communication circuit and the capacitor.

3. The transmitting apparatus using DC carrier in claim 2, further including a power supply circuit electrically connected to the DC output unit, the induction reactance unit, the microcontroller, and the transmitting-side communication circuit.

4. The transmitting apparatus using DC carrier in claim 3, wherein the transmitting-side communication circuit is an encoding circuit; the induction reactance unit is a choke; the power supply circuit is a voltage regulator.

5. The transmitting apparatus using DC carrier in claim 4, further including:
a connector connected to the DC output unit;
a pipe connected to the connector;
a wire connector arranged corresponding to the pipe; and
a housing connected to the pipe and the wire connector.

6. A receiving apparatus using DC carrier applied to a DC power receiving unit and an information signal receiving unit, the receiving apparatus using DC carrier including:
a microcontroller electrically connected to the information signal receiving unit;
a receiving-side communication circuit electrically connected to the microcontroller;
an induction reactance unit electrically connected to the DC power receiving unit;
a DC isolation unit electrically connected to the receiving-side communication circuit and the induction reactance unit; and
a DC power and signal input terminal electrically connected to the induction reactance unit and the DC isolation unit,
wherein an information signal is sent from the receiving-side communication circuit to the microcontroller after a communication signal sent from the DC power and signal input terminal and through the DC isolation unit is received by the receiving-side communication circuit; the information signal is sent from the microcontroller to the information signal receiving unit after the information signal is received by the microcontroller; a DC power is sent from the DC power and signal input terminal to the DC power receiving unit through the induction reactance unit; the DC power and the communication signal are hereby sent from an electric wire to the DC power and signal input terminal.

7. The receiving apparatus using DC carrier in claim 6, wherein the DC isolation unit includes:
a capacitor electrically connected to the induction reactance unit and the DC power and signal input terminal; and
an isolation transformer electrically connected to the receiving-side communication circuit and the capacitor.

8. The receiving apparatus using DC carrier in claim 7, further including a power supply circuit electrically connected to the DC power receiving unit, the induction reactance unit, the microcontroller, and the receiving-side communication circuit.

9. The receiving apparatus using DC carrier in claim 8, wherein the receiving-side communication circuit is a decoding circuit; the induction reactance unit is a choke; the power supply circuit is a voltage regulator.

10. The receiving apparatus using DC carrier in claim 9, further including:
a connector connected to the DC power receiving unit;
a pipe connected to the connector;
a wire connector arranged corresponding to the pipe;
a housing connected to the pipe and the wire connector; and
a connection wire connected to the housing.
